(19) United States
(12) Patent Application Publication
(10) Pub. No.: US 2009/0161656 A1
(43) Pub. Date: Jun. 25, 2009

(54) METHOD AND SYSTEM FOR FRAME SIZE ADAPTATION IN REAL-TIME TRANSPORT PROTOCOL

(76) Inventors: Jari Vikberg, Jarna (SE); Tomas Nylander, Varmdo (SE); Kakan Niska, Linkoping (SE); Tomas Bornefall, Linkoping (SE)

Correspondence Address: ERICSSON INC., 6300 LEGACY DRIVE, M/S EVR 1-C-11, PLANO, TX, 75024, US

(21) Appl. No.: 11/574,490

(22) PCT Filed: Aug. 30, 2005
(86) PCT No.: PCT/SE05/01269

§ 371 Date: Nov. 12, 2008

Related U.S. Application Data
(63) Continuation-in-part of application No. 10/969,375, filed on Oct. 20, 2004.
Application No. PCT/SE05/01269 is a continuation-in-part of application No. 10/977,684, filed on Oct. 29, 2004, now Pat. No. 7,266,106.
(60) Provisional application No. 60/606,044, filed on Aug. 31, 2004.
(60) Provisional application No. 60/606,044, filed on Aug. 31, 2004.
(60) Provisional application No. 60/606,044, filed on Aug. 31, 2004.

(51) Int. Cl. H04L 12/66

(52) U.S. Cl. 370/352

(57) ABSTRACT

A system and method for adapting circuit-switched payload transport between a mobile station, MS, (30) and an unlicensed-radio access network utilizing the Real-Time Transport Protocol, RTP. The MS (30) and an access network controller (103) negotiate the number of speech/data frames per RTP packet during the assignment of a traffic channel. The network controller notifies (62) the MS of a requested or minimum acceptable sample size, and the MS utilizes that sample size, if able, to send (86) RTP packets to the network controller. If the MS is not capable of utilizing that sample size, the MS utilizes the closest sample size that the MS can support to send (89) packets to the network controller. The network controller then calculates (90) the sample size utilized by the MS and utilizes (91) the calculated sample size in transmissions to the MS. Thereafter, if network conditions change, another negotiation is initiated (94-97) to adapt the sample size to the changed conditions.

### TECHNICAL FIELD OF THE INVENTION

The present invention relates generally to communications networks, and in particular, to a system and method for adapting circuit-switched (CS) payload transport between a mobile station and an unlicensed-radio access network utilizing the Real-Time Transport Protocol (RTP).

### DESCRIPTION OF RELATED ART

When voice data is transported over an IP network, the chosen transport protocol is generally the Real-Time Transport Protocol (RTP). This protocol is conventionally used to transport different kinds of synchronized media, such as video or voice coded with different codecs. RTP is carried over the User Datagram Protocol (UDP). For this reason, the end points of an active voice session using RTP are generally identified using an IP address, i.e. network address, and a UDP port or transport level identifier. The use of RTP enables one or more speech samples to be carried in one RTP package.

The Unlicensed Radio service utilizes an unlicensed radio band to support mobile telecommunication systems operating in licensed radio bands. For example, the Unlicensed Radio service may support Global System for Mobile Communications (GSM) circuit-switched services and GSM Packet Radio Service (GPRS) packet-switched services.

A packet-switched voice session is set-up using a signaling protocol, such as the Session Initiation Protocol (SIP), H-323 or another proprietary or standard protocol. During set-up of the voice session, each party signals to the other party the identifiers that have been locally selected for the voice session.

When a circuit switched call (speech or data) is set up, the network controller specifies the number of speech/data frames that must be used in each RTP package. This is specified as the sample size for the RTP package (which can be converted to a number of 20 ms voice/data samples). If the MS cannot support this requirement, the MS cannot proceed, and the call is terminated.

This problem can be avoided by specifying that a greater number of speech/data frames be used in each RTP package. This enables less capable MSs to proceed with call setup. A disadvantage is that the greater number of speech/data frames in each RTP package increases the delay in the transmission between the MS and the network controller. Thus, the system must be set up either for low delay (some MSs cannot be served) or for higher delay (high performance MSs unnecessarily have higher round trip delay).

Additionally, once a session has begun, there are no procedures for changing the sample size during the ongoing session in order to adapt to changing network conditions.

It would be advantageous to have a system and method that overcomes the disadvantages of the existing methodology. The present invention provides such a system and method.

### SUMMARY OF THE INVENTION

The present invention individually serves MSs with different capabilities by adapting the circuit-switched (CS) payload transport between each individual MS and the unlicensed-radio access network controller. This is done by negotiating the number of speech/data frames per RTP package during the assignment of a traffic channel. The access network controller notifies the MS of a requested or minimum acceptable sample size, and the MS utilizes the requested or minimum acceptable sample size, if able, to send RTP packets to the network controller. If the MS is not capable of utilizing the requested or minimum acceptable sample size, the MS selects the closest sample size that the MS can support and uses the selected sample size in RTP packets that it sends to the network controller. In one embodiment, the network controller checks the received RTP packets and automatically adopts the sample size utilized by the MS. Thereafter, if network conditions change to the point that a different sample size is needed, another negotiation is initiated to change the sample size for the ongoing session.

Thus in one aspect, the present invention is directed to a method of adapting circuit-switched payload transport between a mobile station and an unlicensed-radio access network controller utilizing a packet-based transmission protocol. The method includes receiving in the mobile station, a channel activation message from the access network controller that includes a requested sample size of the circuit-switched payload to be included in each packet. The mobile station determines whether it is capable of supporting communications that utilize the requested sample size, and if so, transmits packets to the controller utilizing the requested sample size. If the mobile station is not capable of supporting communications that utilize the requested sample size, the mobile station transmits packets to the controller utilizing a selected sample size supported by the mobile station. The controller then transmits packets to the mobile station utilizing the sample size transmitted by the mobile station.

In a further aspect, the requested sample size is a minimum acceptable sample size of the circuit-switched payload to be included in each packet. The method may also include sending an acknowledgment message from the mobile station to the access network controller accepting the minimum acceptable sample size as the sample size to be utilized by the controller for transmissions to the mobile station.

The method may also include detecting by either the mobile station or the access network controller, a change in network performance; and in response to the detected change in network performance, negotiating a new sample size to transport the circuit-switched payload between the access network controller and the mobile station.

In another aspect, the present invention is directed to a system in an unlicensed-radio access network for transporting a circuit-switched payload utilizing a packet-based transmission protocol. The system includes an unlicensed-radio access network controller, which comprises a transmitter that sends to a mobile station, a channel activation message that includes a requested sample size of the circuit-switched payload to be included in each packet. The controller also includes a receiver that receives packets transmitted in return by the mobile station; means for analyzing the received packets to determine the sample size utilized by the mobile station; and a codec that encodes transmissions to the mobile station utilizing the determined sample size.

In a further aspect, the access network controller also includes means for detecting a change in network performance, and means for determining a suggested sample size in response to the detected change in network performance. The transmitter then sends a message to the mobile station with the suggested sample size, and the receiver receives an acknowledgment message from the mobile station accepting the suggested sample size.

In a further aspect, the system also includes a mobile station, which comprises a receiver that receives the channel activation message from the access network controller and extracts from the channel activation message, the requested sample size. A sample size analyzer receives the extracted requested sample size from the receiver and determines whether the mobile station is capable of supporting communications that utilize the requested sample size. If not, the analyzer selects a different sample size that the mobile station can support. The mobile station also includes a transmitter that transmits packets to the controller. The transmitter utilizes the requested sample size if the mobile station is capable of supporting communications that utilize the requested sample size. If the mobile station is not capable of supporting communications that utilize the requested sample size, the transmitter transmits packets to the controller utilizing the selected different sample size that the mobile station can support.

### BRIEF DESCRIPTION OF THE DRAWINGS

Further objects and advantages of the present invention will become apparent from the following description of the preferred embodiments that are given by way of example with reference to the accompanying drawings wherein:

FIG. 1 is a simplified block diagram of an unlicensed-radio access network suitable for implementing the present invention;

FIG. 2 is a signaling diagram showing the signaling messages sent between the MS and the Unlicensed Radio Network Controller (UNC) during traffic channel activation;

FIG. 3 is a chart showing the content of the URR ACTIVATE CHANNEL message;

FIG. 4 is a chart of the Sample Size information element (IE);

FIG. 5 is a table showing various values of Sample Size that may be selected by the MS according to the present invention;

FIG. 6 is a flow chart illustrating the steps of a first exemplary embodiment of a method of initial sample size assignment during channel activation;

FIG. 7 is a simplified block diagram of an exemplary embodiment of the system of the present invention;

FIG. 8 is a flow chart illustrating the steps of a second exemplary embodiment of a method of initial sample size assignment during channel activation; and

FIG. 9 is a signaling diagram showing the signaling messages sent between the UNC and the MS when an assigned sample size is changed during an ongoing session.

### DETAILED DESCRIPTION OF EMBODIMENTS

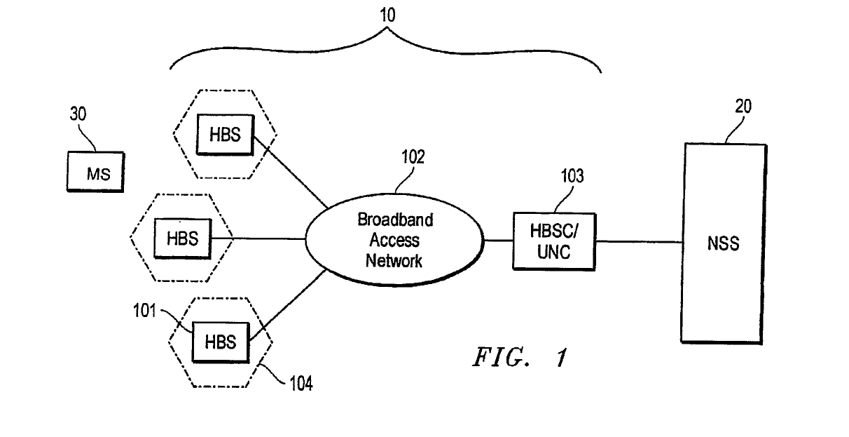

FIG. 1 is a simplified block diagram of an unlicensed-radio access network suitable for implementing the present invention. The unlicensed-radio access network enables mobile stations to communicate with the core network portion of a conventional mobile communications network, such as a GSM network, and through this other communication networks, via an unlicensed-radio interface. The term “unlicensed-radio” means any radio protocol that does not require the operator running the mobile network to have obtained a license from the appropriate regulatory body. In general, such unlicensed-radio technologies must be low power and thus of limited range compared to licensed mobile radio services. A benefit of this lower power is that the battery lifetime of mobile stations is greater. Moreover, because the range is limited the unlicensed-radio may be a broadband radio, thus providing improved voice quality. The radio interface may utilize any suitable unlicensed-radio protocol, for example a wireless LAN protocol, Digital Enhanced Cordless Telecommunications (DECT), or Bluetooth radio.

The access network 10 comprises an access controller, hereinafter referred to as a home base station controller HBSC or more generally, an Unlicensed-radio Network Controller (UNC) 103, which communicates with the core network portion of a conventional cellular mobile communications network NSS 20 over standard interfaces, such as the A- or Gb-interface for a GSM cellular network. The UNC 103 is connected to a plurality of access points or home base stations (HBS) 101 via a broadband packet-switched network 102. The packet-switched network 102 may be a dedicated private network or part of an already existing network, preferably with access to the Internet. The packet-switched network may be connected to various other devices and nodes, and may also access other private and public networks. The HBSs are adapted to communicate across an unlicensed-radio interface with mobile stations/terminals 30 and to this end, comprise radio transceivers that define a coverage area or cell 104 in a similar manner to the operation of a conventional base station transceiver.

The HBSs 101 may be dedicated entities in the access network 10 that are registered with the UNC 103 and are capable of establishing a connection with a mobile station 30 independently of a connection with the UNC. Alternatively, the HBSs may serve as access points to the unlicensed-radio access network 10 that are essentially transparent to both mobile stations 30 and the UNC. In this latter case, a mobile station 30 establishes a connection directly with the UNC across the broadband packet-switched network 102 and vice versa. Both the UNC and the HBSs have a network address on the broadband network. During the set up of a voice session between these two nodes, each node allocates a network address as a source address for receiving voice data, and communicates this to the other node. This address is then conventionally used by the receiving node as the destination address for the synchronized data stream in the opposite direction.

The broadband packet-switched network 102 carries data between the various nodes, i.e. the HBSs 101 and the UNC 103 using the Internet Protocol (IP). Voice data is carried over the network using the Real-Time Protocol (RTP) over User Datagram Protocol UDP over IP. RTP is commonly used on top of IP to transport different kinds of synchronized media data, such as video, voice (encoded using different codecs), or music. The network source address for the synchronized data in a voice session includes both an IP-address and a UDP port, which is the transport level identifier.

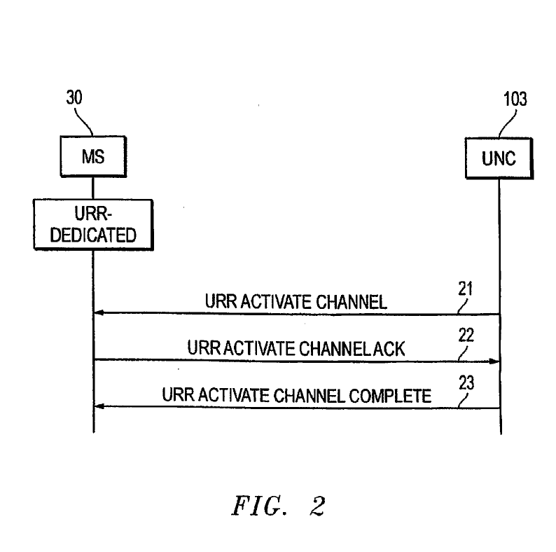

FIG. 2 is a signaling diagram showing the signaling messages sent between a URR-dedicated MS 30 and the UNC 103 during traffic channel activation. The Channel Assignment procedure is always initiated by the network. Upon receiving an Assignment Request from a Mobile Switching Center (MSC) (not shown), the UNC configures a traffic channel by transmitting a URR ACTIVATE CHANNEL message 21 to the MS 30. The URR ACTIVATE CHANNEL message can be sent to the MS only when the MS is in URR-DEDICATED state.

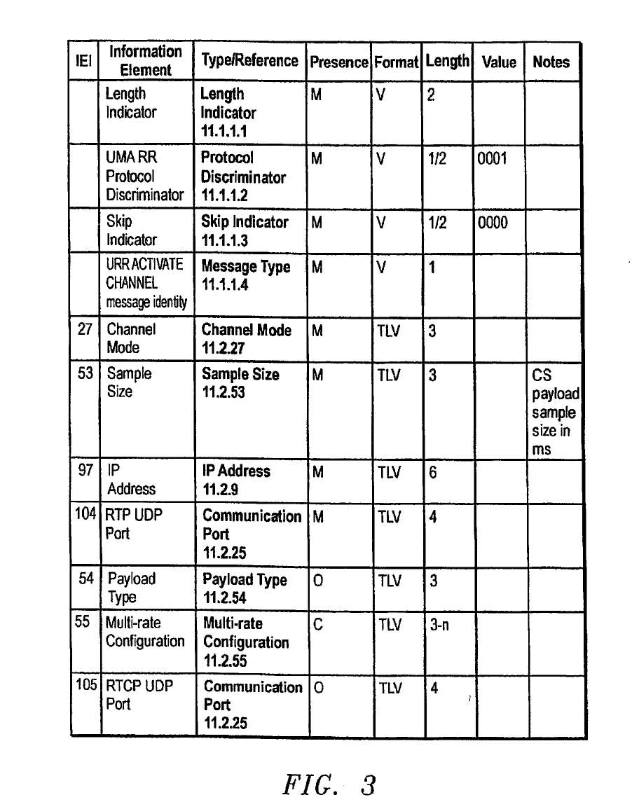

FIG. 3 is a chart illustrating the various information elements (IEs) of the URR ACTIVATE CHANNEL message 21.

Referring to FIGS. 2 and 3, the remainder of the traffic channel assignment procedure will be described. Using existing RTP procedures, the URR-dedicated MS 30 responds to the received URR ACTIVATE CHANNEL message 21 as follows:
Code and decode the CS payload samples according to the IE “Channel Mode”;
Use the value of the IE “Sample Size” as the sampling size for the coding and decoding of the CS payload samples;
Configure the uplink CS payload stream to be transmitted to the UDP port identified by the IE “UDP Port”;
Configure the uplink CS payload stream to be transmitted to the IP address identified by the IE “IP address”;
If received, use the configuration included in the IE ‘Multi-rate Configuration’ for the CS payload stream;
If received, use the Payload Type included in the IE ‘Payload Type’ for the PT field in the RTP header for the CS payload stream;
On successful activation of the channel:
Transmit a URR ACTIVATE CHANNEL ACK message 22 and include the UDP port number in the IE “UDP Port” for the downlink CS payload stream to be used by the UNC; and
If the IE ‘RTCP UDP Port’ was received in the URR ACTIVATE CHANNEL message and the MS is capable of supporting RTCP, activate the uplink RTCP stream and include the IE ‘RTCP UDP Port’ for the downlink RTCP stream to be used by the UNC.

Thereafter, the UNC 103 configures itself for transmission of RTP packets to the MS 30. The UNC then transmits a URR ACTIVATE CHANNEL COMPLETE message 23 to the MS.

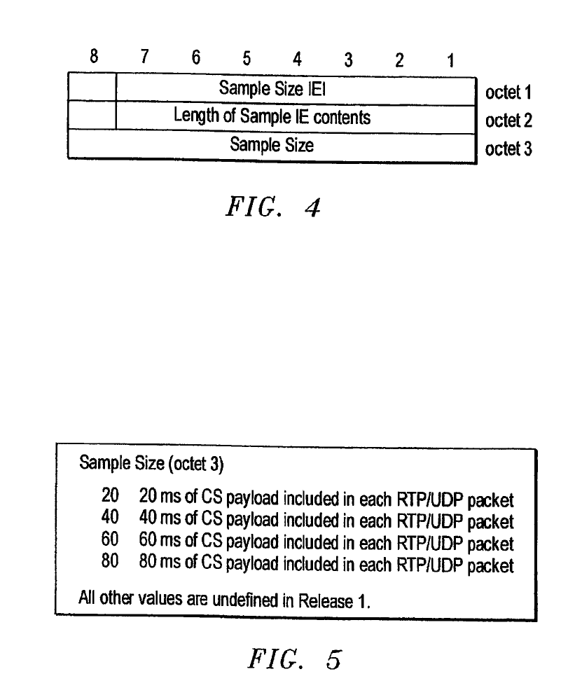

FIG. 4 is a chart of the Sample Size information element (IE). The Sample Size IE is used by the network in the URR ACTIVATE CHANNEL message 21 to indicate the size of the CS payload frames to be included in each RTP/UDP packet.

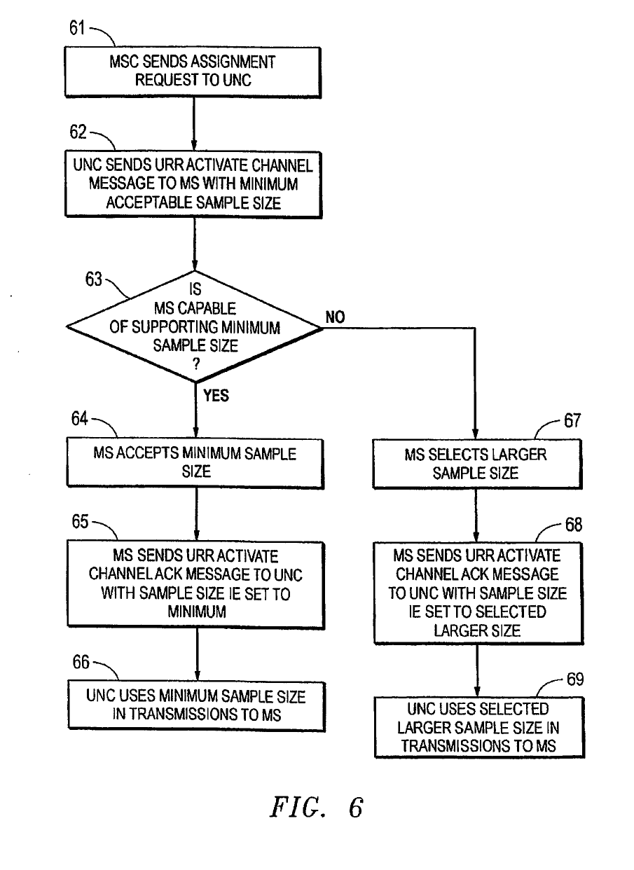

FIG. 5 is a table showing various values of Sample Size that may be selected by the MS according to the present invention. The Sample Size may vary, for example, in 20-ms steps from 20 ms to 80 ms of CS payload included in each RTP/UDP packet.

If the MS 30 fails to establish the channel indicated in the URR ACTIVATE CHANNEL message 21, the MS transmits a URR ACTIVATE CHANNEL FAILURE message (not shown) to the UNC 103 and thereafter acts as if the URR ACTIVATE CHANNEL message was not received.

The present invention causes the MS 30 to interpret the “Sample Size” IE, not as an absolute requirement from the network, but rather as a minimum sample size acceptable to the network for the coding and decoding of the CS payload samples. Thus, rather than forcing the MS to use the value of the “Sample Size” IE as the sampling size for the coding and decoding of the CS payload samples, the MS has the option to accept the minimum sample size or to select a larger sample size for the connection. High performance MSs can accept the minimum sample size and thus avoid the higher round trip delay inherent in larger sample sizes. Likewise, lower performance MSs can select a larger sample size. When the UNC 103 detects that an MS has selected a larger sample size, the UNC also begins using the larger sample size in transmissions to the MS. Thus lower performance MSs are not being precluded from channel assignment, and can proceed with the call.

FIG. 6 is a flow chart illustrating the steps of a first exemplary embodiment of a method of initial sample size assignment during channel activation. At step 61, an MSC sends an Assignment Request message to the UNC 103. At step 62, the UNC sends a URR ACTIVATE CHANNEL message to a URR-dedicated MS 30, and includes a minimum acceptable Sample Size. At step 63, the MS determines whether it is capable of supporting the minimum Sample Size included in the URR ACTIVATE CHANNEL message. If so, the MS accepts the minimum Sample Size at step 64 and sends a URR ACTIVATE CHANNEL ACK message to the UNC at step 65. The URR ACTIVATE CHANNEL ACK message includes a Sample Size IE set to the minimum Sample Size. Thereafter, at step 66, the UNC uses the minimum Sample Size in transmissions to the MS, thereby avoiding increased delay in transmissions between the MS and the network controller that would result from the use of larger Sample Sizes.

If it is determined at step 63 that the MS is not capable of supporting the minimum Sample Size included in the URR ACTIVATE CHANNEL message, the MS selects a larger Sample Size at step 67. At step 68, the MS sends a URR ACTIVATE CHANNEL ACK message to the UNC with the Sample Size IE set to the selected larger Sample Size. Thereafter, at step 69, the UNC uses the selected larger Sample Size in transmissions to the MS. In this way, less capable MSs are not precluded from channel assignment, and can proceed with the call.

Note that if the MS is capable of using the Sample Size requested by the UNC in the URR ACTIVATE CHANNEL message, it does so. The UNC may request a particular Sample Size for network reasons such as controlling the load on a heavily loaded network. If the MS cannot support the requested Sample Size, it selects a Sample Size as close to the requested Sample Size as possible.

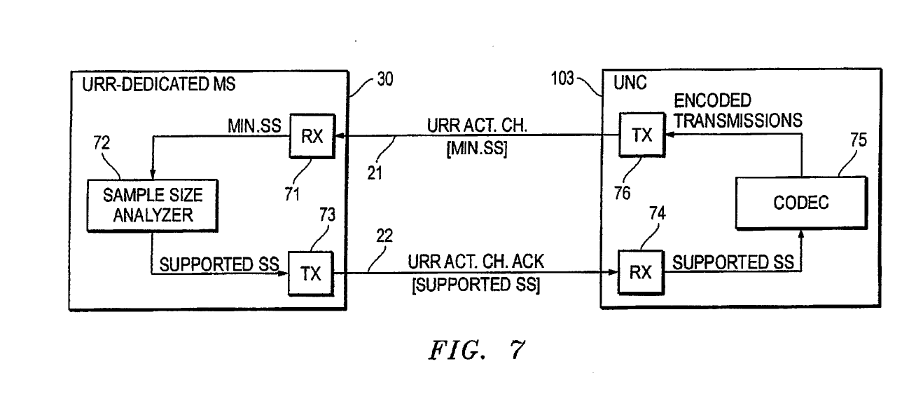

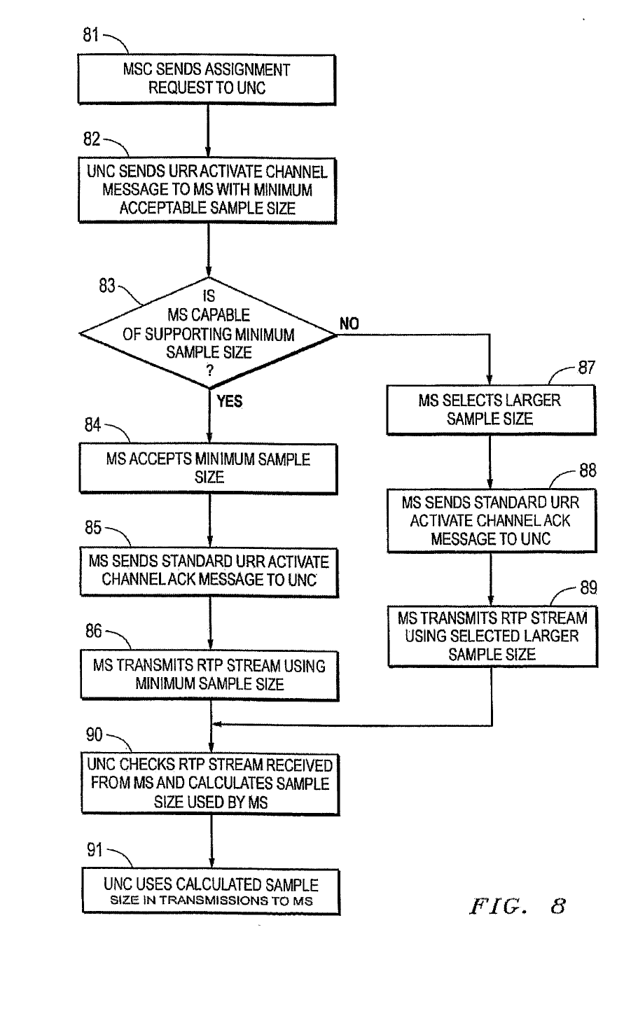

FIG. 7 is a simplified block diagram of an exemplary embodiment of the system of the present invention. The URR-dedicated MS 30 includes a receiver (RX) 71, a Sample Size Analyzer 72, and a transmitter (TX) 73. The UNC 103 includes a receiver (RX) 74, a codec 75, and a transmitter (TX) 76. The MS 30 and the UNC 103, of course, include many other components that are not shown. However, the illustrated components are sufficient to illustrate the operation of the present invention to those skilled in the art.

The UNC 103 transmits a URR ACTIVATE CHANNEL message 21 to the URR-dedicated MS 30, and includes a minimum acceptable Sample Size (Min SS). The MS RX 71 sends the Min SS to the Sample Size Analyzer 72, which determines whether the MS is capable of supporting the minimum Sample Size included in the URR ACTIVATE CHANNEL message. The Sample Size Analyzer sends the lowest Sample Size that the MS can support (Supported SS) to the MS TX 73, which sends the Supported SS to the UNC in a URR ACTIVATE CHANNEL ACK message 22. The UNC RX 74 receives the message and sends the Supported SS to the codec 75. Thereafter, the codec encodes transmissions to the MS using the Supported SS.

FIG. 8 is a flow chart illustrating the steps of a second exemplary embodiment of a method of initial sample size assignment during session establishment. In this embodiment, the MS does not use a Sample Size IE in the URR ACTIVATE CHANNEL ACK message. Instead, the MS sends the ACK message without a Sample Size, and then selects a Sample Size and starts transmitting an RTP stream using the selected Sample Size. The UNC checks the RTP stream received from the MS and calculates the Sample Size being used by the MS. Thereafter, the UNC uses the calculated Sample Size in transmissions to the MS.

The process begins at step 81 where the MSC sends an Assignment Request message to the UNC 103. At step 82, the UNC sends a URR ACTIVATE CHANNEL message to the URR-dedicated MS 30, and includes a minimum acceptable Sample Size. At step 83, the MS determines whether it is capable of supporting the minimum Sample Size included in the URR ACTIVATE CHANNEL message. If so, the MS accepts the minimum Sample Size at step 84 and sends a standard URR ACTIVATE CHANNEL ACK message to the UNC at step 85. At step 86, the MS begins transmitting an RTP stream to the UNC using the minimum sample size.

However, if it is determined at step 83 that the MS is not capable of supporting the minimum Sample Size included in the URR ACTIVATE CHANNEL message, the MS selects a larger Sample Size at step 87. At step 88, the MS sends a standard URR ACTIVATE CHANNEL ACK message to the UNC. At step 89, the MS begins transmitting an RTP stream to the UNC using the selected larger sample size.

At step 90, the UNC checks the RTP stream received from the MS and calculates the sample size being utilized by the MS. Thereafter, at step 91, the UNC uses the calculated Sample Size in transmissions to the MS.

In another embodiment, if the MS is capable of using the Sample Size requested by the UNC in the URR ACTIVATE CHANNEL message, it does so. The UNC may request a particular Sample Size for network reasons such as controlling the load on a heavily loaded network. If the MS cannot support the requested Sample Size, it selects a Sample Size as close to the requested Sample Size as possible. The selected Sample Size may be larger or smaller than the requested Sample Size. For example, suppose the MS can support 2 or 3 voice samples per RTP packet. If the UNC requests 2 voice sample per RTP packet, the MS selects 2 voice samples per RTP packet. If the UNC requests 1 voice sample per RTP packet, the MS selects 2 voice samples per RTP packet because a Sample Size of 2 is the closest Sample Size to the requested Sample Size that the MS can support. Likewise, if the UNC requests 4 voice sample per RTP packet, the MS selects 3 voice samples per RTP packet because a Sample Size of 3 is the closest Sample Size to the requested Sample Size that the MS can support.

In a further aspect of the invention, if the UNC 103 or the MS 30 detects changing network conditions that affect network performance during a session, either side can initiate a negotiation to change parameters used for the ongoing session. For example, they can initiate a negotiation to change the sample size used or to apply redundancy coding. Two messages that already exist in the UMA specifications are modified in the present invention to achieve this purpose: the URR CHANNEL MODIFY message and the URR CHANNEL MODIFY ACK message. These messages currently do not include the sample size parameter. The invention adds the sample size parameter so that the sample size can be changed during an ongoing session.

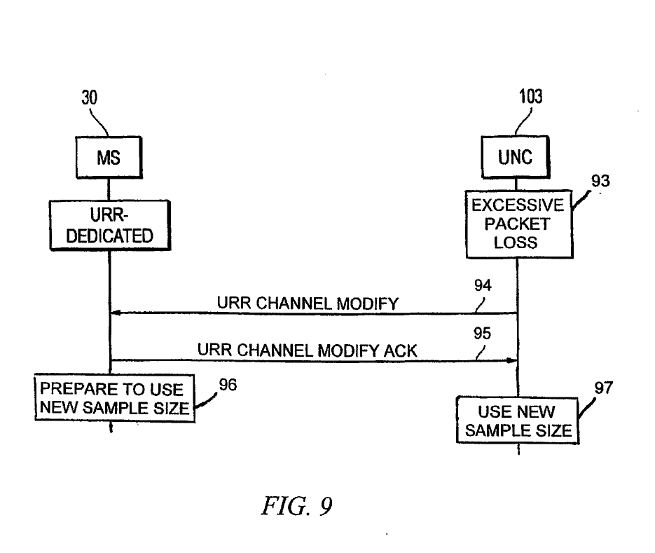

FIG. 9 is a signaling diagram showing the signaling messages sent between the UNC 103 and the MS 30 when the sample size is changed during an ongoing session. If the UNC detects a deteriorating network condition or reduction in network performance related to the session with the MS 30 (for example, as shown at 93, the UNC 103 may detect an excessive packet loss), the UNC sends a URR CHANNEL MODIFY message 94 to the MS suggesting that a larger sample size should be used. If the MS is capable of using the suggested larger sample size, the MS replies with the URR CHANNEL MODIFY ACK message 95 indicating that the suggested larger sample size is acceptable. At 96, the MS then prepares its receiver 71 and transmitter 73 to use RTP with the new sample size. If the MS cannot handle the suggested larger sample size, the MS may either indicate the largest sample size it can handle (and prepare the receiver 71 and transmitter 73 for that size), or reply with the current used frame size. When the UNC receives the URR CHANNEL MODIFY ACK message, the UNC begins at 97 to use the new sample size.

This procedure may also be initiated from the MS if the MS detects changed network conditions that affect the assigned sample size. In one embodiment, the MS simply begins using a proposed sample size. The UNC detects the change in the sample size and begins to use the proposed sample size as well.

It should be noted that the above example involves a scenario in which the detected network performance has decreased, and therefore the UNC and the MS negotiate a larger sample size in order to maintain acceptable performance for the ongoing session. It is also possible that an increase in network performance may be detected, and in order to conserve network resources or release resources for allocation to other users, the UNC and MS may negotiate a smaller sample size for the ongoing session. Obviously, regardless of whether the sample size is increased or decreased, if another change in network conditions is detected during the session, the sample size may again be modified in accordance with the newly detected network conditions. In order to avoid renegotiating the sample size every time a small change is detected, the UNC and MS may renegotiate the sample size only when the change in network performance exceeds a predefined threshold change limit.

These procedures can also be utilized to control other parameters that affect or improve the voice quality of the session. For example, the procedures can be utilized to control whether redundancy coding should be applied, or whether redundant packets should be transmitted. For this purpose, a new information element is included in the URR ACTIVATE CHANNEL message, the URR CHANNEL MODIFY message, and their respective ACK messages indicating if and to what extent redundancy coding and transmissions should be used. The Redundancy Info IE may indicate exactly how redundancy coding should be applied, or alternatively may define a rule set for the application of redundancy coding. For example, the Redundancy Info IE may specifically indicate that the session should use Adaptive Multi-Rate (AMR) speech coding with 4.75 kbit/s and Forward Error Correction (FEC). The end points may negotiate to arrive at a combination that both sides can handle. Alternatively, for the rule set case, the Redundancy Info IE may merely indicate the rules for changing the redundancy coding. Thus, all of the changes do not have to be signaled on the control plane. Instead, the changes are determined locally in the MS and the voice codec on the network side.

In one example, a Multi-rate Configuration IE defines a number of AMR modes that can be used during a voice session, such as AMR 12.2 (12.2 kbit/s) or AMR 4.75 (4.75 kbit/s). A request to change the AMR codec mode is signaled in-band in a ‘Codec Mode Request’ (CMR). Within the MS and the UNC/Media Gateway (MGW), the change in the AMR mode can be tied to an associated redundancy coding. For example, AMR 12.2 has been associated with no redundancy coding, and AMR 4.75 has been associated with redundancy coding using the Redundancy Info IE. The URR CHANNEL ACTIVATE message or URR CHANNEL MODIFY message and their respective ACK messages with the Redundancy Info IE are used to define the associations so that if a certain frame loss rate is detected in the MS or network codec, the session should begin using AMR 4.75 and redundancy coding. Rules controlling when to change the codec mode, and thereby redundancy (i.e., thresholds and hysteresis) may be signaled as well or may be predetermined. Note that both the MS and network sides are prepared for this change, because it was negotiated earlier, and so the specifics of the change do not need to be signaled on the control plane.

Information elements in the modified URR CHANNEL MODIFY message include all of the information elements from the URR ACTIVATE CHANNEL message. These information elements include:
Channel Mode (already included);
Sample Size (as described above);
Redundancy Info IE (as described above);
IP Address, to move the session to another IP interface/Media Gateway;
RTP UDP Port, to move the session to another UDP port (in another IP interface/Media Gateway);
Payload Type, to change the Payload Type dynamically;
Multi-rate Configuration, to change all parameters related to a multi-rate speech codec; and
RTCP UDP Port, to move the RTCP session to another UDP port (in another IP interface/Media Gateway).

These information elements provide the capability to dynamically change all values indicated during the initial traffic channel activation.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

The present invention may of course, be carried out in other specific ways than those herein set forth without departing from the essential characteristics of the invention. The present embodiments are, therefore, to be considered in all respects as illustrative and not restrictive and all changes coming within the meaning and equivalency range of the appended claims are intended to be embraced therein.

1. A method of adapting circuit-switched payload transport between a mobile station and an unlicensed-radio access network controller utilizing a packet-based transmission protocol, said method comprising:
receiving in the mobile station, a channel activation message from the access network controller, said channel activation message including a requested sample size of the circuit-switched payload to be included in each packet;
determining whether the mobile station is capable of supporting communications that utilize the requested sample size;
if the mobile station is capable of supporting communications that utilize the requested sample size. transmitting packets to the controller utilizing the requested sample size to transport the circuit-switched payload; and
if the mobile station is not capable of supporting communications that utilize the requested sample size transmitting packets to the controller utilizing a selected sample size supported by the mobile station;
wherein the controller transmits packets to the mobile station utilizing the sample size transmitted by the mobile station.

2. The method of claim 1, wherein the step of transmitting packets to the controller utilizing a selected sample size supported by the mobile station includes selecting a sample size, from the sample sizes supported by the mobile station, which is closest in size to the requested sample size.

3. The method of claim 1, wherein the step of transmitting packets to the controller utilizing a selected sample size supported by the mobile station includes selecting a sample size which is larger than the requested sample size if the mobile station supports a larger sample size.

4. The method of claim 3, wherein the step of transmitting packets to the controller utilizing a selected sample size supported by the mobile station includes selecting a sample size which is smaller than the requested sample size if the mobile station does not support a larger sample size.

5. The method of claim 1, wherein the requested sample size is a minimum acceptable sample size of the circuit-switched payload to be included in each packet.

6. The method of claim 5, further comprising, upon determining that the mobile station is capable of supporting communications that utilize the minimum acceptable sample size, the step of sending an acknowledgment message from the mobile station to the access network controller accepting the minimum acceptable sample size as the sample size to be utilized by the controller for transmissions to the mobile station.

7. The method of claim 6, further comprising, upon determining that the mobile station is not capable of supporting communications that utilize the minimum acceptable sample size, the steps of:
selecting a larger sample size which the mobile station is capable of supporting; and
sending an acknowledgment message from the mobile station to the access network controller specifying the selected larger sample size as the sample size to be utilized by the controller for transmissions to the mobile station.

8. The method of claim 7, wherein the packet-based transmission protocol is the Real-Time Protocol (RTP), and the step of receiving a channel activation message in the mobile station includes receiving a URR ACTIVATE CHANNEL message, and the step of sending an acknowledgment message from the mobile station includes sending a URR ACTIVATE CHANNEL ACK message.

9. The method of claim 7, further comprising the steps of:
receiving in the access network controller, the acknowledgment message from the mobile station; and
encoding transmissions to the mobile station utilizing the sample size received in the acknowledgment message.

10. The method of claim 1, further comprising the steps of:
receiving in the controller, packets transmitted by the mobile station;
analyzing the received packets to determine the sample size utilized by the mobile station; and
encoding transmissions to the mobile station utilizing the determined sample size.

11. The method of claim 10, further comprising, after analyzing the received packets to determine the sample size utilized by the mobile station, the steps of:
determining whether the sample size utilized by the mobile station is equal to or greater than a minimum acceptable sample size for the network controller; and
denying call setup if the sample size utilized by the mobile station is smaller than the minimum acceptable sample size for the network controller.

12. The method of claim 1, further comprising:
detecting by either the mobile station or the access network controller, a change in network performance; and
in response to the detected change in network performance, negotiating a new sample size to transport the circuit-switched payload between the access network controller and the mobile station.

13. The method of claim 12, wherein the detected change in network performance is a reduction in network performance, and the step of negotiating a new sample size includes selecting a larger sample size in response to the detected reduction in network performance.

14. The method of claim 12, wherein the detected change in network performance is an increase in network performance, and the step of negotiating a new sample size includes selecting a smaller sample size in response to the detected increase in network performance.

15. The method of claim 12, wherein the step of negotiating a new sample size is performed only when the detected change in network performance exceeds a threshold change limit.

16. The method of claim 12, wherein the access network controller detects the change in network performance, and the step of negotiating a new sample size further comprises:
sending a message from the access network controller to the mobile station with a suggested sample size determined in response to the detected change in network performance; and
receiving an acknowledgment message from the mobile station to the access network controller accepting the suggested sample size.

17. The method of claim 12, wherein the mobile station detects the change in network performance, and the step of negotiating a new sample size includes:
determining the new sample size by the mobile station;
transmitting packets from the mobile station to the access network controller utilizing the new sample size;
detecting the new sample size by the access network controller; and
accepting the new sample size by the access network controller.

18. The method of claim 12, further comprising:
in response to the detected change in network performance, determining that a change in redundancy coding of the packets is required; and
applying to subsequent packets transmitted during the ongoing session, redundancy coding in accordance with the determined change.

19. The method of claim 18, further comprising, after determining that a change in redundancy coding of the packets is required, the step of signaling the change in redundancy coding by transmitting specific redundancy coding parameters between the mobile station and the access network controller.

20. The method of claim 18, wherein the mobile station and the access network controller are configured with a set of redundancy coding rules, and the step of determining that a change in redundancy coding of the packets is required includes determining by the mobile station and the access network controller, the change in redundancy coding in accordance with the redundancy coding rules.

21. The method of claim 20, wherein the redundancy coding rules associate redundancy coding with particular Adaptive Multi-Rate (AMR) modes, which are selected in response to the detected change in network performance.

22. The method of claim 21, wherein the redundancy coding rules also specify a threshold level of change and associated hysteresis value required in the network performance to trigger a change in AMR mode or a change in redundancy coding.

23. The method of claim 12, further comprising:
in response to the detected change in network performance, determining that redundant packets should be transmitted; and
transmitting redundant packets for subsequent packets transmitted between the access network controller and the mobile station.

24. A system in an unlicensed-radio access network for transporting a circuit-switched payload utilizing a packet-based transmission protocol, said system comprising:
an unlicensed-radio access network controller comprising:
a transmitter that sends to a mobile station, a channel activation message,
said channel activation message including a requested sample size of the circuit-switched payload to be included in each packet;
a receiver that receives packets transmitted in return by the mobile station;
means for analyzing the received packets to determine the sample size utilized by the mobile station; and
a codec that encodes transmissions to the mobile station utilizing the determined sample size.

25. The system of claim 24, wherein the receiver also receives an acknowledgment message from the mobile station in response to the channel activation message, said acknowledgment message including a sample size that the mobile station can support, wherein the codec encodes transmissions to the mobile station utilizing the sample size received in the acknowledgment message.

26. The system of claim 24, wherein the requested sample size is a minimum acceptable sample size of the circuit-switched payload to be included in each packet.

27. The system of claim 24, wherein the access network controller also includes:
means for detecting a change in network performance; and
means for determining a suggested sample size in response to the detected change in network performance;
wherein the transmitter sends a message to the mobile station with the suggested sample size, and the receiver receives an acknowledgment message from the mobile station accepting the suggested sample size.

28. The system of claim 24, further comprising:
a mobile station comprising:
a receiver that receives the channel activation message from the access network controller and extracts from the channel activation message, the requested sample size;
a sample size analyzer that receives the extracted requested sample size from the receiver and determines whether the mobile station is capable of supporting communications that utilize the requested sample size, wherein if the mobile station is not capable of supporting communications that utilize the requested sample size, the analyzer selects a different sample size that the mobile station can support; and
a transmitter that transmits packets to the controller utilizing the requested sample size if the mobile station is capable of supporting communications that utilize the requested sample size, and if the mobile station is not capable of supporting communications that utilize the requested sample size, transmits packets to the controller utilizing the selected different sample size that the mobile station can support.

29. The system of claim 28, wherein the requested sample size is a minimum acceptable sample size of the circuit-switched payload to be included in each packet. and the analyzer selects a larger sample size if the mobile station is not capable of supporting communications that utilize the minimum acceptable sample size.

30. The system of claim 27, wherein the mobile station also includes:
means for detecting a change in network performance; and
means for determining a new sample size in response to the detected change in network performance;
wherein the mobile station transmitter transmits packets to the access network controller utilizing the new sample size, and the access network controller detects and accepts the new sample size.
